(19) United States
(12) Patent Application Publication
(10) Pub. No.: US 2008/0043275 A1
(43) Pub. Date: Feb. 21, 2008

(54) Method to Provide Print Functions to The User Via A Camera Interface

(76) Inventors: Charles Morton, Leander, TX (US); Eric Garza, Hutto, TX (US); Divya Jani, Austin, TX (US)

Correspondence Address: HAMILTON & TERRILE, LLP, P.O. BOX 203518, AUSTIN, TX, 78720, US

(21) Appl. No.: 11/464,869

(22) Filed: Aug. 16, 2006

(51) Int. Cl. G06F 3/12

(52) U.S. Cl. 358/1.15

(57) ABSTRACT

A system for providing print functions via a camera interface. The system enables selecting print options via a cameral interface by interacting with an image preference file. In an embodiment, a user initially places a memory card in the printer's card slot. If the card does not have an image preference file, then the printer creates one. The image preference file is specific to the printer and contains a list of options offered by the printer. Next, the user transfers the image preference file to the camera. The user can then use a menu presented on the camera interface via the image preference file to select various options for each image to be printed. The memory card is then inserted into the printer again where the printer accesses the image preference file. The images are then printed according to the options selected by the user. Next, a printer display presents a message asking the user if they would like to reset the file. If the user ignores the message the file is left as is. If the user chooses to reset the file, an empty image preference file is stored on the card.

### BACKGROUND OF THE INVENTION

1. Field of the Invention

The present invention relates to the field of providing print functions to a user via a camera interface.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

People have started taking pictures using digital cameras where the pictures are stored as digital images. Digital images are stored on various media some that are fixed in location (such as hard disks) and others that can be moved or mailed (such as media cards, diskettes, DVDs, or CDROMs). Digital images can also be transferred over communications media such as the internet, local networks, or even a USB (universal serial bus) cable connecting a digital camera to a personal computer. These digital images can be printed via photographic quality printers by, e.g., connecting the digital cameral to the printer or by plugging a media card from the digital camera in to the printer.

Known printers can provide a user with an option of printing a proof sheet. The proof sheet displays small thumbnail versions of some or all of the pictures on the media card inserted into the printer. The users can then select the images that they wish to print, e.g., by shading in circles under each thumbnail for which they desire a print. With some printers, the user can select a few other print options such as size and red eye removal. The proof sheet is then scanned and the printer prints the selected pictures. This method allows a user to print photos from a proof sheet without being connected to a computer system.

### SUMMARY OF THE INVENTION

In accordance with the present invention, a system for providing print functions via a camera interface is set forth. The system enables selecting print options via a cameral interface by interacting with an image preference file. In an embodiment, a user initially places a memory card in the printer's card slot. If the card does not have an image preference file, then the printer creates one. The image preference file is specific to the printer and contains a list of options offered by the printer. Next, the user transfers the image preference file to the camera. The user can then use a menu presented on the camera interface via the image preference file to select various options for each image to be printed. The memory card is then inserted into the printer again where the printer accesses the image preference file. The images are then printed according to the options selected by the user. Next, a printer display presents a message asking the user if they would like to reset the file. If the user ignores the message the file is left as is. If the user chooses to reset the file, an empty image preference file is stored on the card.

In one embodiment, the invention relates to an apparatus for providing print functions. The apparatus includes a processor, a light sensor coupled to the processor, a memory coupled to the processor, a display coupled to the processor, and an image preferences file. The light sensor senses light and generates a digital image corresponding to the light. The image preference file presents print options which enable selection of print functions.

In another embodiment, the invention relates to a method for providing print functions via a camera. The method includes providing the camera with an image preferences file which is specific to a printer, presenting a menu on an interface of the camera using the image preferences file, enabling selection of an image to be printed via the image preferences file, transferring the images to be printed along with the images preference file to the printer, and printing the images according to the options selected.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a system block diagram of an information handling system.

FIG. 2 shows a block diagram of an example digital camera.

FIG. 3 shows a flow chart of the operation of a system for providing print functions via a camera interface

FIG. 4 shows an example view a screen presentation and controls of an example digital camera.

FIG. 5 shows another example of a screen presentation and controls of an example digital camera.

### DETAILED DESCRIPTION

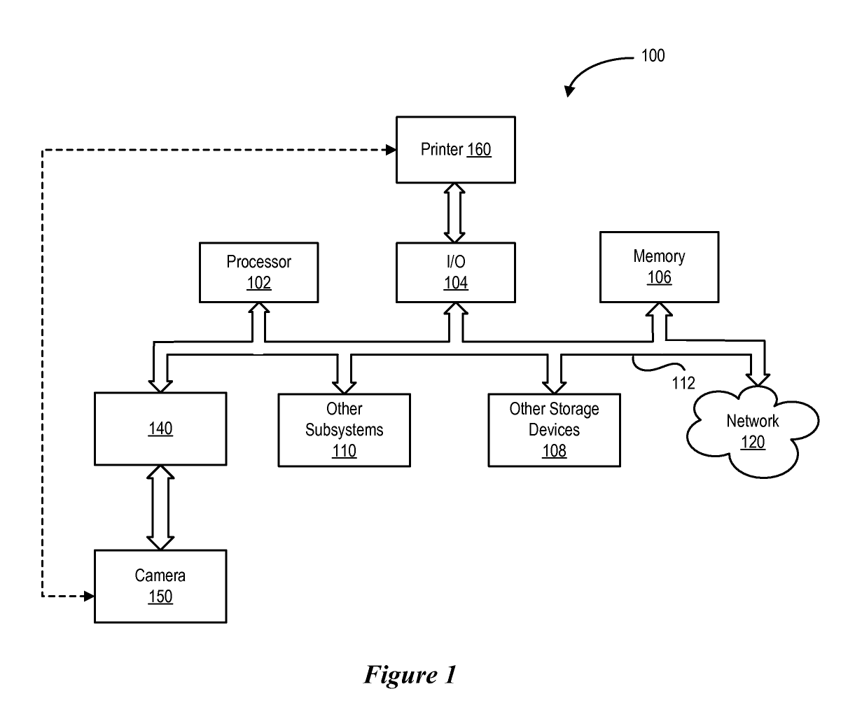

Referring briefly to FIG. 1, a system block diagram of an information handling system 100 is shown. The information handling system 100 includes a processor 102, input/output (I/O) devices 104, such as a display, a keyboard, a mouse, and associated controllers, non volatile memory 106, such as a hard disk and drive, and other storage devices 108, such as a floppy disk and drive and other memory devices, and various other subsystems 110, all interconnected via one or more buses 112. The information handling system 100 may be coupled to a network 120, e.g., via the bus 112. The information handling system may also include a connection device 140 which enables a camera or other type of content (e.g., image data) device to be coupled to the information handling system 100. For example, the information handling system 120 might include a USB or IEEE 1394 type of connector and controller. A printer 160 may be coupled to the information handling system, e.g., via the I/O controllers within the I/O devices 104. The digital camera 150 may also be coupled to the printer 160 either via a cable or by transferring a media device between the camera 150 and the printer 160.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components. Additional examples of an information handling system may be a camera or video recorder.

The camera 150 (e.g., a digital camera) enables users to take pictures and save them in digital (electronic) format. The camera 150 enables users to take pictures (i.e., images), which are saved in memory within the camera 150 as digital image data. After taking and storing the images, the user can connect the digital camera 150 to the information handling system 100 to upload the digital images to the non-volatile memory 106 of the information handling system 100. Alternately, the digital images may be provided directly to the printer 160. Once the digital images are uploaded to the information handling system 100, the user can erase the digital images from the memory of the camera 150 so that the user can take and store additional images using the camera 150. Typically, the camera 150 is connected to the information handling system 100 only while the user is uploading images to the non-volatile memory 106 of the information handling system 100.

After the digital images are stored on the information handing system 100, a user can perform various operations on the digital images. For example, an image viewer application enables viewing the images or a photo editor application enables modifying or touching-up of the images. Also, an electronic messaging (e.g., e-mail) application enables transmission of the digital images to other users.

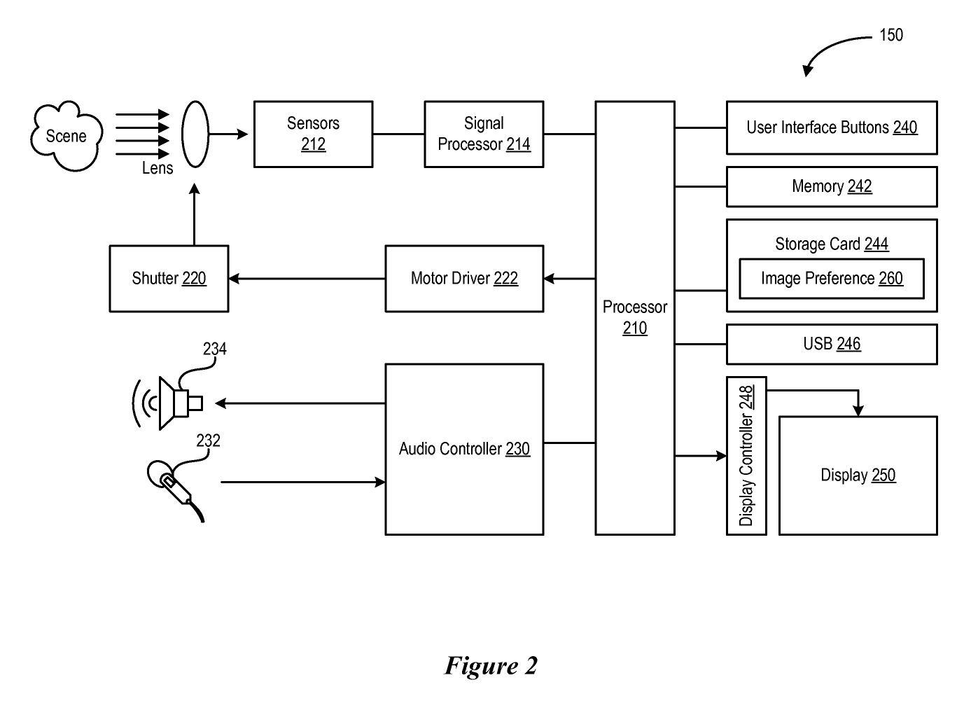

Referring to FIG. 2, a block diagram of an example digital camera 150 is shown. More specifically, an example digital camera 150 includes a processor 210 which is coupled to light sensors 212 (such as a charge coupled device (CCD) or complementary metal oxide semiconductor (CMOS) sensors) via a signal processor 214. The light sensors 212 are coupled to a lens 216. A shutter 220 is controlled via a motor driver 222 to admit light via the lens 216 to the light sensors 212. The motor driver 222 is also coupled to the processor 210.

The processor 210 is also coupled to an audio controller 230. The audio controller is coupled to a microphone 232 as well as a speaker 234.

The processor 210 is also coupled to user interface buttons 240, memory 242, a media device 244 (e.g., a storage card), a universal serial bus connection 246 and a display controller 248. The display controller 246 is in turn coupled to a display 250 such as a liquid crystal display (LCD) type display.

The memory 242 includes both volatile memory such as synchronous dynamic random access memory (SDRAM) and non-volatile memory such as FLASH memory. An image preference file 260 is stored on the memory 244 and executed by the processor 210. The image preference file 260 enables the digital camera 150 provide print functions to a user via a camera interface presented on the display 250.

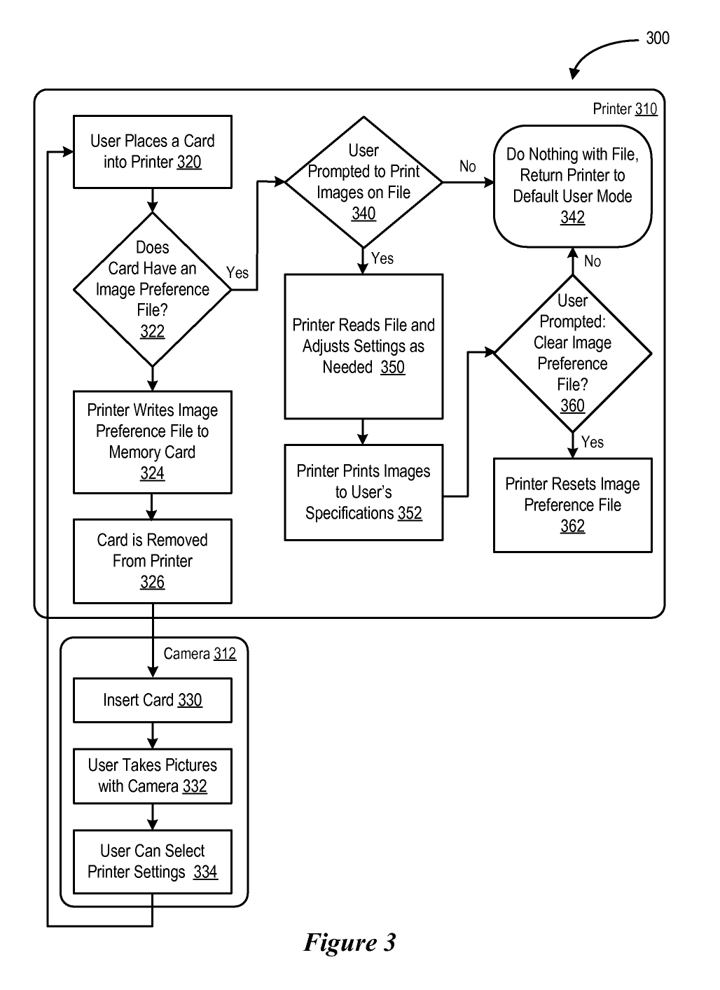

Referring to FIG. 3, a flow chart of the operation of a system for providing print functions via a camera interface is shown. More specifically, the system includes a printer portion 310 and a camera portion 312. The system enables selecting print options via a cameral interface by interacting with an image preference file.

In operation, a user initially places a memory card in a card slot of the printer 160 at step 320. The system 300 then determines whether the media device includes an image preference file at step 322. If the media device does not include an image preference file, then the printer creates such a file at step 324. The image preference file contains a list of options and option value settings that correspond to the particular printer 160. At some time thereafter, the media device is removed from the printer at step 326.

The card is then inserted into a digital camera 150 at step 330 during which the image preference file is transferred to the camera 150. The user then takes pictures with the camera at step 332. The user can then use a menu presented on the display 250 via the image preference file to select various options for each image to be printed at step 334.

The media device 244 is then inserted into the printer 160 again where the printer accesses the image preference file at step 322. The user is then prompted regarding whether to print the images on the media device at step 340. If the user instructs the printer to not print images, then the printer does nothing with the file and the printer is returned to a default user mode at step 342.

If the user indicates a desire to print images, then the printer reads the image preferences file and adjusts the settings of the printer according to the preferences set by the user via the camera 150 at step 350. Next, the images are printed according to the options selected by the user at step 352.

Next, the printer display presents a message asking the user if they would like to reset the file at step 360. If the user ignores the message or indicates a desire to leave the file as is, then the printer does nothing with the file at step 342. If the user chooses to reset the file, an empty image preference file is stored on the card at step 362. The empty (or default) image preference file thus writes over the image preference file that was associated with the pictures that were printed. Accordingly, the image preference file resets the printer settings and options to the default settings and options.

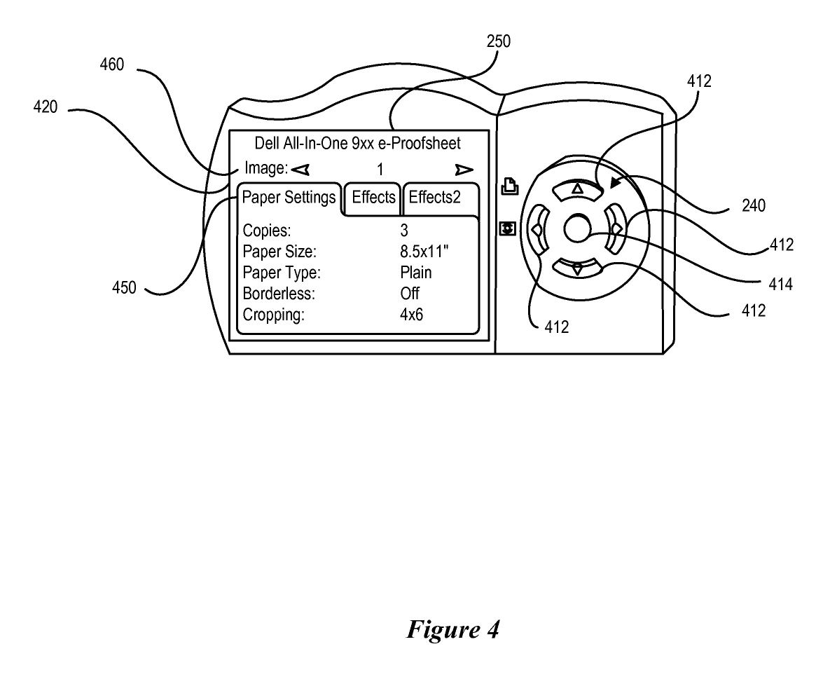

Referring to FIG. 4, a screen presentation and controls of an example digital camera is shown. More specifically, the user interface buttons 240 include navigation buttons 412 and select button 414. A cursor is displayed on the display 250. The cursor is moved up, down, left and right via respective navigation buttons 412. Thus, the navigation buttons 412 function much like a joystick. When the cursor is moved to a specific location for which an action is desired, actuation of the select button 414 enables a user to perform an action on the location.

The display 250 presents a screen presentation 420 based upon information stored within the image preference file 260. The image preference file presents a paper settings tab 450 as well as at least one options tab 452. The particular tab 450, 452 may be selected by the user actuating the select button 414 when the cursor is positioned over the tab.

The image preference file 260 also presents an image navigation portion 460. The image navigation portion 460 enables a user to scroll through the various images stored on the media device 244.

When selected, the paper settings tab 450 provides the user with a plurality of options relating to paper and print settings. For example, the user may select how many copies of the selected image to print, the paper size for the prints, the paper type for the prints, whether to print borderless prints and a size to crop the print. A user uses the user interface buttons 260 to select and change the various paper and print settings. These settings are then stored back to the image preference file 260 for later use by the printer 160. It will be appreciated that other paper and print settings may also be provided.

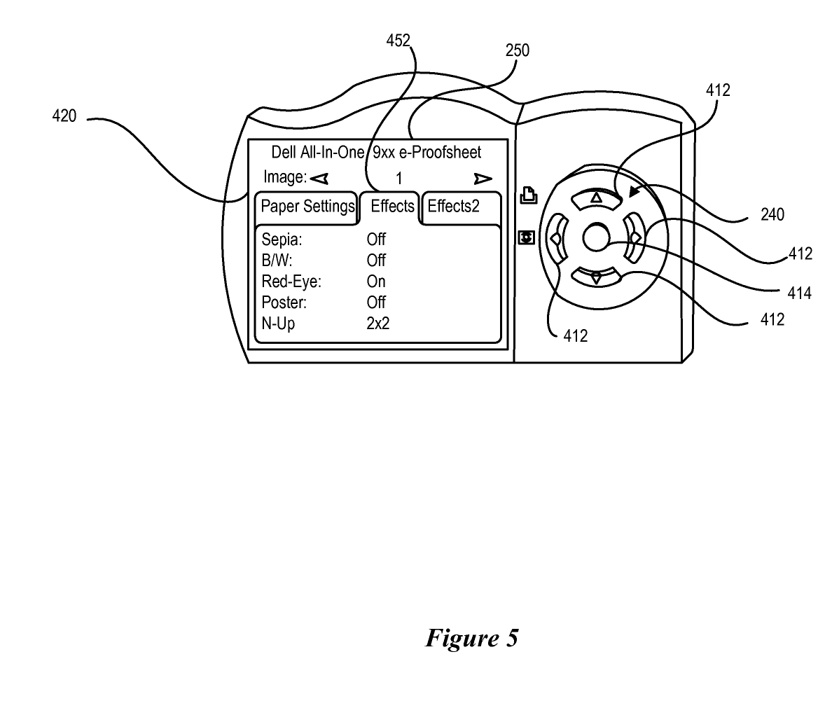

FIG. 5 shows another example of a screen presentation and controls of an example digital camera is shown. More specifically, when the effects tab 452 is selected, the image preference file provides the user with a plurality of options relating to print effects. For example, the effects may include a sepia option, a black and white (B/W) option, a red eye option, a poster option and a multiple reduced images on a page (N-up) option. A user uses the user interface buttons 260 to select and change the various effect settings. These settings are then stored back to the image preference file 260 for later use by the printer 160. It will be appreciated that other effect settings may also be provided.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, other types of peripherals which can generate digital images (e.g., personal digital assistants (PDAs), video cameras, telephones, etc.) are contemplated.

Also for example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. An apparatus for providing print functions comprising:
a processor;
a light sensor coupled to the processor, the light sensor sensing light and generating a digital image corresponding to the light;
a memory coupled to the processor;
a display coupled to the processor; and,
an image preferences file, the image preference file causing print options to be presented via the display, the print options enabling selection of print functions via the display.

2. The apparatus of claim 1 wherein:
the image preferences file is stored on a media device.

3. The apparatus of claim 2 wherein:
the image preferences file includes print options corresponding to a specific printer.

4. The apparatus of claim 3 wherein:
the print options corresponding to the specific printer are stored in the image preference file by the printer.

5. The apparatus of claim 1 further comprising:
user interface buttons coupled to the processor, the user interface buttons interacting with the image preference file to enable a user to navigate within the print options presented via the display.

6. The apparatus of claim 1 wherein:
the print options include paper and print settings.

7. The apparatus of claim 6 wherein:
the paper and print settings include at least one of how many copies of a selected image to print, a paper size for the image to print, a paper type, whether to print borderless prints and a size to crop the image to print.

8. The apparatus of claim 1 wherein:
the print options include effects.

9. The apparatus of claim 1 wherein:
the effects include at least one of a sepia option, a black and white (B/W) option, a red eye option, a poster option and a multiple reduced images on a page (N-up) option.

10. An apparatus for providing print functions comprising:
a processor;
a light sensor coupled to the processor, the light sensor sensing light and generating a digital image corresponding to the light;
a memory coupled to the processor;
a display coupled to the processor; and,
an image preferences file, the image preference file causing print options to be presented via the display, the print options enabling selection of print functions via the display.

11. The apparatus of claim 10 wherein:
the image preferences file is stored on a media device.

12. The apparatus of claim 10 wherein:
the image preferences file includes print options corresponding to a specific printer.

13. The apparatus of claim 12 wherein:
the print options corresponding to the specific printer are stored in the image preference file by the printer.

14. The apparatus of claim 12 further comprising:
user interface buttons coupled to the processor, the user interface buttons interacting with the image preference file to enable a user to navigate within the print options presented via the display.

15. The apparatus of claim 12 wherein:
the print options include paper and print settings.

16. The apparatus of claim 14 wherein:
the paper and print settings include at least one of how many copies of a selected image to print, a paper size for the image to print, a paper type, whether to print borderless prints and a size to crop the image to print.

17. The apparatus of claim 12 wherein:
the print options include effects.

18. The apparatus of claim 17 wherein:
the effects include at least one of a sepia option, a black and white (B/W) option, a red eye option, a poster option and a multiple reduced images on a page (N-up) option.

19. A method for providing print functions via a camera comprising:
providing an image preferences file to the camera, the image preference file being specific to a printer;
presenting a menu on an interface of the camera using the image preferences file;
enabling selection of image to be printed via the image preferences file;
transferring the images to be printed along with the images preference file to the printer; and
printing the images according to the options selected.

20. The method of claim 19 further comprising:
presenting via a printer display an option of resetting the image preferences file; and,
resetting the image preference file when the option of resetting the image preferences file is selected.

21. The method of claim 19 wherein:
the image preferences file is stored on a media device.

22. The method of claim 19 wherein:
the image preferences file includes print options corresponding to the printer.

23. The method of claim 22 wherein:
the print options corresponding to the specific printer are stored in the image preference file by the printer.

24. The method of claim 22 wherein:
the camera includes user interface buttons coupled, the user interface buttons interacting with the image preference file to enable a user to navigate within the print options presented via the display.

25. The method of claim 22 wherein:
the print options include paper and print settings.

26. The method of claim 25 wherein:
the paper and print settings include at least one of how many copies of a selected image to print, a paper size for the image to print, a paper type, whether to print borderless prints and a size to crop the image to print.

27. The method of claim 22 wherein:
the print options include effects.

28. The method of claim 27 wherein:
the effects include at least one of a sepia option, a black and white (B/W) option, a red eye option, a poster option and a multiple reduced images on a page (N-up) option.
